(19) United States
(12) Patent Application Publication
(10) Pub. No.: US 2007/0297842 A1
(43) Pub. Date: Dec. 27, 2007

(54) IMAGE FORMING APPARATUS

(75) Inventor: Junji SHIROKOSHI, Nagano-ken (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 11/755,017

(22) Filed: May 30, 2007

(30) Foreign Application Priority Data
May 31, 2006 (JP) 2006-150988

(51) Int. Cl. B41J 11/42

(52) U.S. Cl. 400/76

(57) ABSTRACT

There is provided an image forming apparatus comprising an apparatus main body connected to a plurality of option units by way of communication lines by cascade connection and adapted to communicate with an element to be controlled and a unit type determining means arranged in each of the plurality of option units by way of the communication lines, and the communication lines including: data signal lines connecting the element to be connected arranged in each of the plurality of option units in parallel relative to the apparatus main body for data communications between each of the elements to be controlled and the apparatus main body, unit type determination signal lines connecting the unit type determination means arranged respectively for the plurality of option units to the apparatus main body for data communications between each of the unit type determination means and the apparatus main body, and selection control lines arranged corresponding to the number of cascade-connected option units relative to the apparatus main body to select an option unit as object of data communication of the apparatus main body.

### CROSS-REFERENCE TO RELATED APPLICATIONS

This application is based upon and claims the benefit of priority from prior Japanese Patent Application No. 2006-150988, filed May 31, 2006, the entire contents of which are incorporated herein by reference.

### BACKGROUND OF THE INVENTION

1. Field of the Invention

This invention relates to an image forming apparatus for transferring a latent image formed on an image carrier onto an intermediate transfer body, the apparatus having an option unit to be mounted in the main body of the image forming apparatus.

2. Description of the Related Art

Image forming apparatus equipped with one or more than one option units for use such as a multiple sheet feed unit and/or a finisher unit according to user's choice are known. Such option units are normally equipped with elements to be controlled for detecting its operation state and driving the movable parts of the apparatus such as various sensors and actuators. Therefore, communication lines for controlling the elements to be controlled need to be extended between the apparatus main body and each option unit.

When an image forming apparatus is equipped with a plurality of option units, these units need to be controlled individually. Generally, a technique for connecting option units by cascade connection is employed. Additionally, a device and a communication method for connecting the apparatus main body and the option units by way of a common bus line and transmitting various data by serial communications on a time division basis have been proposed for the purpose of reducing the number of communication lines (see JP 2001-106352-A).

With such a proposed technique, each option unit is provided with a decoding/encoding means such as a communication module or a serial/parallel converter and the serial data transmitted through a communication line is converted into a control signal for controlling sensors or the like.

Such a known technique is effective particularly when a large number of units are mounted because the number of communication lines does not increase if the number of units is raised. However, the communication module or the like that each unit is to be provided comprises relatively expensive parts and hence there arises a problem or raising the overall cost of the apparatus. Additionally, the signal transmission rate is low because many data are transmitted serially on a time division basis and the resistance of the apparatus against the noises that get in to the communication lines is poor.

To solve these problems, there has been proposed an image forming apparatus wherein a plurality of option units are connected to the apparatus main body by way of communication lines so that each of the elements to be controlled arranged in the plurality of option units communicates with the apparatus main body by way of a communication line and the communication lines connects the elements to be controlled that are arranged in the plurality of option units to the apparatus main body in parallel, the communication lines including data signal lines for data communications between each of the elements to be controlled and the apparatus main body, and selection control lines provided corresponding to the number of connectable option units relative to the apparatus main body and adapted to select option units as objects of data communication with the apparatus main body (see JP 2004-170889-A).

With an image forming apparatus as described above, the elements to be controlled that are arranged in a plurality of option units shares data signal lines and multiplexed. Therefore, it is possible to remarkably reduce the number of communication lines connecting the option units and the apparatus main body if compared with an arrangement where each option unit is connected to the apparatus main body by way of a signal line. On the other hand, the selection control lines for selecting option units as objects of data communication are arranged relative to the individual option units so that it is possible to individually and reliably control the option units. Furthermore, it is possible to realize high-speed communications because each option unit can be selected by only operating the selection control line that corresponds to the option unit.

However, with the above-described prior art, while it is possible to mount a plurality of option units, they can be operated only in certain conditions that limit the structures and the positional arrangements of the option units. For example, when a plurality of sheet feed units adapted to contain a large number of sheets and having different heights are mounted in the main body of an image forming apparatus and the mounting positions of the sheet feed units are made to be vertically interchangeable, the length of the sheet conveyance route from each sheet feed unit to the image forming apparatus main body becomes different from unit to unit. Then, it is no longer possible to clearly define a reference for judging a stuck sheet condition. In other words, the sheet feed units need to be mounted in predefined respective positions. Additionally, image forming apparatus adapted to be operated in a low speed operation mode in order to control the apparatus so as to prolong the fixing time when an image is to be formed on a cardboard are known. However, it is not possible for the prior art to detect the sheet feed unit that contains cardboards when the mounting positions of the sheet feed units are made to be vertically interchangeable. Then, it is not possible to control and modify the timing of operation of the components of the sheet conveying system.

### SUMMARY OF THE INVENTION

In view of the above-identified circumstances, it is therefore the object of the present invention to dissolve the above problems by providing an image forming apparatus that can arrange option units of an appropriately selected number of different types at appropriately selected positions and connect them to itself.

According to the present invention, the above problems are dissolved by providing an image forming apparatus comprising an apparatus main body connected to a plurality of option units by way of communication lines by cascade connection and adapted to communicate with an element to be controlled and a unit type determining means arranged in each of the plurality of option units by way of the communication lines; and the communication lines including: data signal lines connecting the element to be connected arranged in each of the plurality of option units in parallel relative to the apparatus main body for data communications between each of the elements to be controlled and the apparatus main body; unit type determination signal lines connecting the unit type determination means arranged respectively for the plurality of option units to the apparatus main body for data communications between each of the unit type determination means and the apparatus main body; and selection control lines arranged corresponding to the number of cascade-connected option units relative to the apparatus main body to select an option unit as object of data communication of the apparatus main body. Thus, the elements to be controlled arranged in each of the plurality of option units and the unit type determination means share data signal lines and multiplexed. Therefore, it is possible to remarkably reduce the number of communication lines if compared with an arrangement where each option unit is connected to the apparatus main body individually.

As for the selection control lines for selecting an option unit as object of data communication, selection control lines are arranged to correspond to the respective option units so that it is possible to reliably and individually control the option units. Additionally, since an option unit can be selected only by operating the selection control line that corresponds to the option unit, it is possible to realize high-speed communications.

The apparatus main body is characterized in that it is adapted to form an electric current flow path between the element to be controlled arranged in an option unit that corresponds to one of the selection control lines out of the option units and the unit type determination means and the apparatus main body itself by way of the data signal lines by activating the selection control line. Thus, it is possible to select an option unit by operating the selection control line that corresponds to the option unit to open/close the electric current flow path between the element to be controlled on the option unit and the apparatus main body that are connected to each other by way of data signal lines. Such a control operation can be conducted easily at high speed.

Additionally, each of the plurality of option units is characterized in that it is equipped with an upstream side connector for electrically connecting the communication lines between the option unit and the option unit cascade-connected at the upstream side and arranged closer to the apparatus main body in terms of order of connection or the apparatus main body and a downstream side connector for electrically connecting the communication lines between the option unit and the option unit cascade-connected at the downstream side and arranged at the side opposite to the upstream side in terms of order of connection. Thus, it is possible to mutually connect any desired number of option units, securing the communication lines between each of the option units and the apparatus main body.

The upstream side connector arranged in each of the plurality of option units, the main body side connector arranged in the apparatus main body and the downstream side connector arranged in each of the plurality of option units have a structure that allows them to be mutually connected. Thus, the option units are interchangeable in terms of mutual connection.

Each option unit is provided in the inside thereof with a relay substrate for mutually connecting the straight connection harnesses that are connected respectively to the upstream side connector and the downstream side connector. Such straight connection harnesses can be manufactured by means of an automated machining system to reduce the manufacturing cost. Particularly, when a substrate for mounting an element to be controlled and other component is arranged in an option unit, the substrate can be used as relay substrate.

The plurality of option units are characterized in that the internal wiring of each of them is arranged between the upstream side connector and the downstream side connector thereof in such a way that the contact point of the upstream side connector assigned to the selection control line corresponding to the option unit is same throughout the option units. Thus, it is sufficient for each option unit to operate, regarding the communication line connected to the fixed contact point as the selection control line that corresponds to the unit regardless of the order of connection of option units. In other words, the option units are not required to have different internal circuits and hence allowed to have a same circuit configuration. As option units are made to have common internal wiring, it is possible to reduce the manufacturing cost by using common components and the option units connected to the image forming apparatus are interchangeable in terms of the order of connection. Thus, it is possible to configure a variety of systems to meet the requirements of users.

Additionally, since a plurality of option units are made to be functionally identical, when the elements to be controlled of a plurality of option units are functionally identical or similar, it is possible to effectively reduce the number of communication lines by making the elements to be controlled share data signal lines.

Since the unit type determination means can determine the type of an option unit simply by opening/closing the contact point, it is possible for an existing image forming apparatus to discriminate a large number of unit types simply by adding a few number of components. Then, it is possible to increase the number of option units with ease.

Still other objects and advantages of the invention will in part be obvious and will in part be apparent from the specification.

The invention accordingly comprises the features of construction, combinations of elements and arrangement of parts which will be exemplified in the construction hereinafter set forth, and the scope of the invention will be indicated in the claims.

### BRIEF DESCRIPTION OF THE DRAWINGS

The invention will be described with reference to the accompanying drawings, wherein like members reference like elements.

FIG. 1 is a schematic illustration of an embodiment of image forming apparatus according to the present invention;

FIG. 2 is a schematic block diagram of the embodiment of FIG. 1;

FIG. 3 is a schematic connection diagram of the multiple sheet feed unit of the embodiment of FIG. 1;

FIG. 4 is a schematic connection circuit diagram of the multiple sheet feed unit of the embodiment of FIG. 1;

FIGS. 5A and 5B are signal detection timing charts of the embodiment of FIG. 1; and

FIGS. 6A and 6B are schematic illustrations of the operation of controlling different units of the embodiment of FIG. 1.

### DETAILED DESCRIPTION OF THE EXEMPLARY EMBODIMENTS

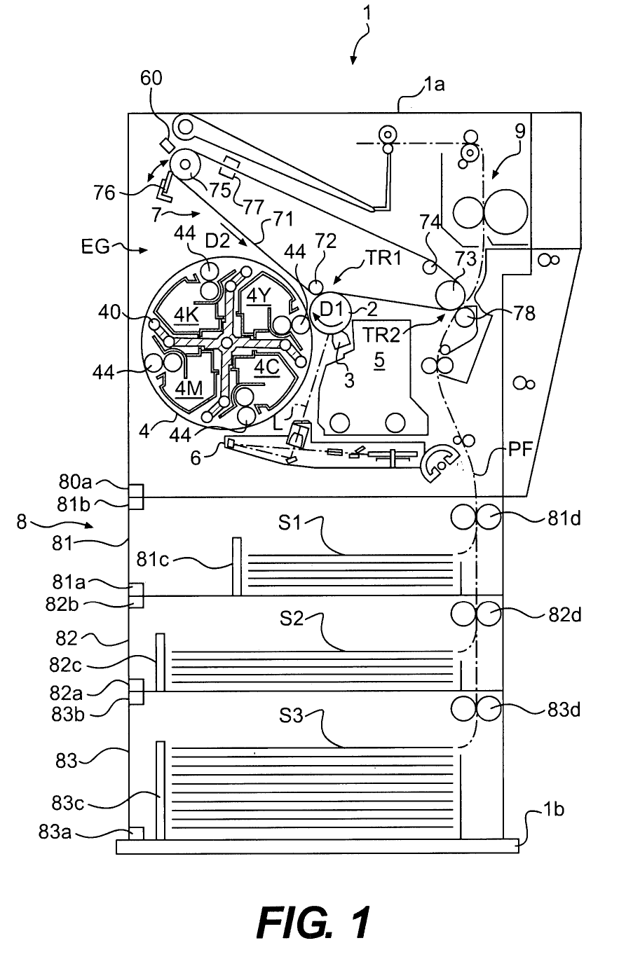

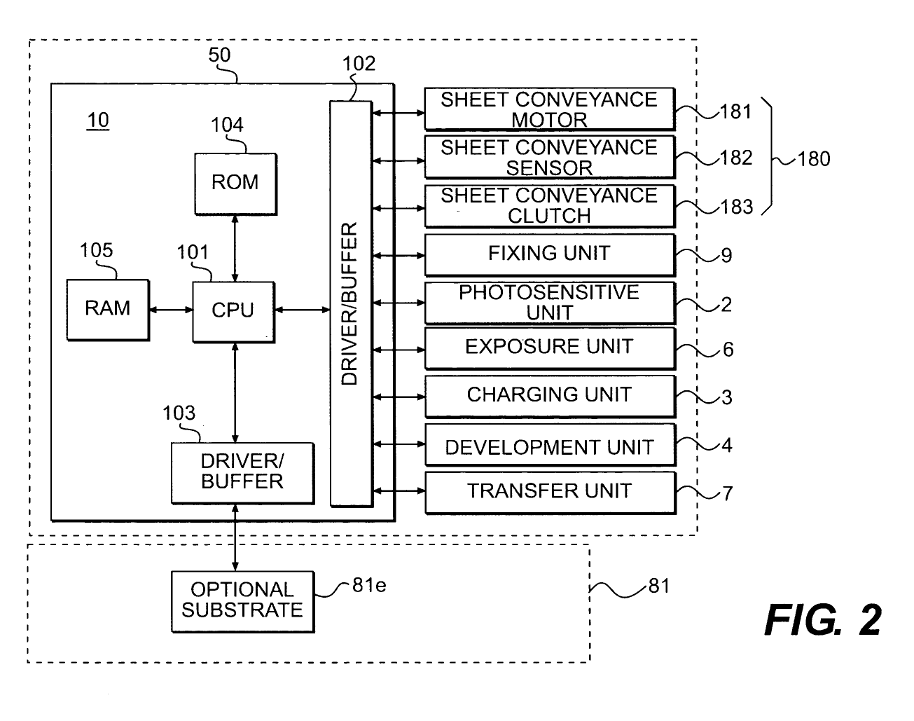

Now, the present invention will be described in greater detail by referring to the accompanying drawings that illustrate a preferred embodiment of the invention. FIG. 1 is a schematic cross sectional lateral view of an embodiment of image forming apparatus according to the present invention. FIG. 2 is a schematic block diagram of the embodiment of image forming apparatus of FIG. 1, illustrating the electric configuration thereof. The image forming apparatus can form full color image by laying toners of four colors including yellow (Y), cyan (C), magenta (M) and black (K) and monochromatic images by using only black (K) toner.

The image forming apparatus 1 of this embodiment is adapted to receive a video signal from an external apparatus such as a host computer by means of a main controller (not shown) in response to a request of a user for forming one or more than one images. Then, a command signal is transmitted from the main controller to an engine controller 10. The engine controller 10 controls each part of the engine section EG according to the command signal to form an image that corresponds to the video signal on a sheet S (recording medium).

A photosensitive member 2 is arranged in the engine section EG so as to operate as “an image carrier” that can freely rotate in the direction of arrow D1 in FIG. 1. A charging unit 3, a rotary development unit 4 and a cleaning section 5 are arranged around the photosensitive member 2 in the mentioned order in the rotary direction D1. A charging bias is applied to the charging unit 3 from a charging control section to electrically uniformly charge the outer peripheral surface of the photosensitive member 2 to a surface potential.

Then, a light beam L is irradiated onto the outer peripheral surface of the photosensitive member 2 that is electrically uniformly charged by the charging unit 3 from an exposure unit 6, that is, an optical device. The exposure unit 6 exposes the outer peripheral surface of the photosensitive body 2 to the light beam L according to the control command given from an exposure control section to form an electrostatic latent image that corresponds to the video signal. The exposure unit 6 includes appropriate optical elements such as a lens and a mirror.

The exposure unit 6 also includes a scanner motor that is a DC motor for driving optical elements such as a rotary polygon mirror. The charging unit 3, the rotary development unit 4, the exposure unit 6 and other units that are provided for forming images are replaceable. The service life management information of each of the units is stored in a RAM 105, which will be described in greater detail hereinafter.

As a video signal is applied to the CPU of the main controller from an external apparatus such as a host computer by way of an interface, the CPU 101 of the engine controller 10 outputs a control signal that corresponds to the video signal to the exposure control section at a predetermined timing. Then, a light beam L is irradiated from the exposure unit 6 onto the photosensitive member 6 according to the control signal to form an electrostatic latent image that corresponds to the video signal on the photosensitive member 2.

The electrostatic latent image that is formed in the above-described manner is turned into a toner image by the rotary development unit 4. More specifically, in this embodiment, the rotary development unit 4 is provided with a support frame 40 that can freely rotate around an axis, a rotary drive section (not shown) and other components along with developing devices 4Y, 4C, 4M and 4K for yellow, cyan, magenta and black respectively that contain toners of the respective colors and are fitted to the support frame as removable devices. The developing devices 4Y, 4C, 4M, 4K are realized in the form of toner cartridges and mounted as replaceable devices.

The rotary development unit 4 is controlled by a development device control section. The rotary development unit 4 is driven to rotate according to a control command from the development control section. The development devices 4Y, 4C, 4M, 4K are selectively centered at a predetermined development position located vis-à-vis the photosensitive member 2 to apply toner of the selected color to the surface of the photosensitive member 2. Then, as a result, the electrostatic latent image on the photosensitive member 2 is turned to a visible image of the selected toner color.

The rotary development unit 4 forms a patch image of each of the colors by means of the engine controller 10 in advance to the operation of forming an image in an image forming region. Such a patch image is formed solely by a patch of a solid image (Vdc patch) or by a patch of a solid image and a fine line patch (E patch). A fine line patch is formed by a so-called “1 on 10 off” process of forming a patch image of a single line and not forming any image for 10 lines in the sub-scanning direction. The main controller 11 forms an image of a tone patch to determine a density adjustment pattern. A tone patch is formed by laying a single color or a plurality of colors on the image carrier.

In the image forming apparatus, the development roller 44 of the development device that is centered at the development position (the development device 4Y for yellow in the instance of FIG. 1) is placed vis-à-vis the photosensitive member 2 and held in contact with the latter or separated from the latter by a predetermined gap. The development roller 44 operates as a toner bearing member for bearing frictionally charged toner on the surface thereof. As the development roller 44 rotates, toners of different colors are sequentially conveyed to the position thereof disposed vis-à-vis the photosensitive member 2 on the surface of which electrostatic latent images are formed.

A development bias formed by superposing a DC voltage and an AC voltage one on the other is applied to the development roller 44 from the development device control section. The toner borne on the development roller 44 is made to partially adhere to areas of the surface of the photosensitive member 2 according to the surface potentials of the latter by the development bias. Then, the electrostatic latent image on the photosensitive member 2 is visualized as a toner image of the color of the toner. The toner images developed by the development unit 4 in the above-described manner are transferred onto intermediate transfer belt (intermediate transfer member) 71 of transfer unit 7 in primary transfer region TR1. The transfer unit 7 includes an intermediate transfer belt 71 wound around a plurality of rollers 72 through 75 and a drive section (not shown) for driving the intermediate transfer belt 71 to rotate in a predetermined sense of rotation D2 by driving the roller 73 to rotate. A secondary transfer roller 78 is arranged at a position opposite to the roller 73 with the intermediate transfer belt 71 interposed between them. The secondary transfer roller 78 is adapted to be brought into contact with and moved away from the intermediate transfer belt 71 by an electromagnetic clutch (not shown).

When a color image is to be transferred onto a sheet S (recording medium), the toner images of the different colors formed on the photosensitive member 2 are laid one on the other on the intermediate transfer belt 71 to produce a color image. Then, the color image is and transferred for a secondary transfer onto the sheet S that is taken out from the sheet feed unit 8 and conveyed to the secondary transfer region TR2 between the intermediate transfer belt 71 and the secondary transfer roller 78. The sheet S on which the color image is formed is then conveyed out to a delivery tray section arranged on the upper surface of the apparatus main body by way of a fixing unit 9. The rotary development unit 4 is made to operate as means for forming images of the different colors on a same recording medium.

The photosensitive member 2 from which the toner images have been transferred onto the intermediate transfer belt 71 for a primary transfer is then reset for the surface potential thereof by a charge elimination means (not shown). Additionally, the toner remaining on the surface of the photosensitive member 2 is removed by a cleaning section 5 and subsequently electrically charged for the next time by the charging unit 3. The toner removed by the cleaning section 5 is collected in a toner tank (not shown).

A cleaner 76, a density sensor 60 and a vertical synchronism sensor 77 are arranged near the roller 75. Of these devices, the cleaner 76 can be moved close to and away from the roller 75 by means of an electromagnetic clutch (not shown). As the cleaner 76 is moved to the side of the roller 75, the blade of the cleaner 76 is brought into contact with the surface of the intermediate transfer belt 71 wound around the roller 75 to remove the toner remaining on and adhering to the outer peripheral surface of the intermediate transfer belt 71 after the secondary transfer process. The toner removed by the blade of the cleaner 76 is then collected in the transfer waste toner tank.

The vertical synchronism sensor 77 is a sensor for detecting the reference position of the intermediate transfer belt (intermediate transfer member) 71. It is adapted to operate as vehicle synchronism sensor for obtaining the synchronizing signal output in relation to the operation of rotary driving the intermediate transfer belt 71, or vertical synchronizing signal Vsync. In this apparatus, the operations of the components thereof are controlled according to the vertical synchronizing signal Vsync so as to arrange the timings of operation of the components in order and lay the toner images of the different colors accurately one on the other. Finally, the density sensor 60 is arranged vis-à-vis the surface of the intermediate transfer belt 71 so as to gauge the optical density of the patch image that is formed on the outer peripheral surface of the intermediate transfer belt 71 in a density control process.

Now, a sheet feed unit 8 will be described below as an example of option unit. The sheet feed unit 8 is mounted between the main body 1a and the base section 1b of the image forming apparatus 1. More specifically, the sheet feed unit 8 includes a first sheet feed unit 81, a second sheet feed unit 82 and a third sheet feed unit 83 that are laid one above the other as a stack. In this embodiment, the first sheet feed unit 81 is a large capacity sheet feed unit capable of containing 500 sheets and the second sheet feed unit 82 is an ordinary sheet feed unit capable of containing 250 sheets, while the third sheet feed unit 83 is one that can contain sheets of special paper such as cardboards or OHP sheets. The sheet feed units 81, 82, 83 are functionally same and identical.

In the image forming apparatus 1 of this embodiment, the connectors arranged at a lower position of the image forming apparatus main body 1a and at upper and lower positions of each sheet feed unit 8 are adapted to be mutually engaged. More specifically, as shown in FIG. 1, a connector 80a is arranged at a lower position of the image forming apparatus main body 1a and another connector 81b is arranged at an upper part of the first sheet feed unit 81 so as to become engaged with each other. Additionally, a connector 81a is arranged at a lower position of the first sheet feed unit 81 and another connector 82b is arranged at an upper position of the second sheet feed unit 82 so as to become engaged with each other. Still additionally, connectors 82a, 83a that are structurally identical with the connector 81a are fitted respectively to a lower position of the second sheet feed unit 82 and to a lower position of the third sheet feed unit 83, while a connector 83b that is structurally identical with the connector 81b is fitted to an upper position of the third sheet feed unit 83.

Thus, the connectors 80a, 81a, 82a, 83a arranged respectively at the lower positions of the image forming apparatus main body 1a and the first, second and third sheet feed units 81, 82, 83 are structurally identical, whereas the connectors 81b, 82b, 83b arranged respectively at the upper positions of the first, second and third sheet feed units 81, 82, 83 are structurally identical. With this arrangement, it is possible to mount sheet feed units in any desired order relative to the image forming apparatus main body 1a in the image forming apparatus 1.

As the image forming apparatus main body 1a and the sheet feed units 81, 82, 83 are connected to each other by way of the connectors, the image forming apparatus main body 1a and the sheet feed units 81, 82, 83 are connected to each other for cascade connection by way of communication lines. In this embodiment, the connector 80a arranged at the lower position of the image forming apparatus main body 1a is referred to as main body side connector, while the connectors 81b, 82b, 83b arranged at the respective upper positions of the sheet feed units 81, 82, 83 are referred to as upstream side connectors and the connectors 81a, 82a, 83a arranged at the respective lower positions of the sheet feed units 81, 82, 83 are referred to as downstream side connectors.

The first sheet feed unit 81, the second sheet feed unit 82 and the third sheet feed unit 83 are respectively provided with sheet guides 81c, 82c, 83c that can slide. As the user sets the sheet guide of any of the sheet feed units at a position that corresponds to the size of the sheets contained in it, the corresponding one of the sheet size detection sensors arranged on the sliding track of the sheet feed unit is turned on as will be described in greater detail hereinafter.

When the image forming apparatus forms an image according to a printing command issued from an external apparatus by using the sheet feed unit 8 having the above-described structure, one or more than one sheets that correspond to the size or the type of the image to be formed are selected and an image is formed on the sheet or each of the sheets. Differently stated, the image forming apparatus main body 1a grasps the presence or absence and the size or the type of sheets in each of the sheet feed units 81, 82, 83 so that, as a printing command is issued from the external apparatus, the image forming apparatus main body 1a selects one of the sheet feed units 8 that corresponds to the size or the type of the image to be formed. If, for example, the image forming apparatus main body 1a selects the sheet feed unit 81 where sheets S1 are set, the sheet feed roller 81d of the selected sheet feed unit 81 is driven to operate and a sheet S1 is taken out from the sheet feed unit 81 and conveyed to the inside of the image forming apparatus main body 1a along the sheet conveyance route PF. A predetermined image is transferred on the sheet S1 in the inside of the image forming apparatus main body 1a and the sheet S1 on which the image is transferred is discharged to the sheet delivery tray section at an upper part of the apparatus.

The development devices (toner cartridges) 4Y, 4C, 4M, 4K are provided with respective memories that are “memory elements”, each of which stores data relating to the manufacture lot, the operation history and the amount of the contained remaining toner of the development device. Additionally, the development devices 4Y, 4C, 4M, 4K are also provided with respective connectors.

Whenever necessary, the connectors are selectively connected to the corresponding connectors arranged at the side of the main body. Thus, the CPU 101 of the engine controller 10 and the memories exchange data by way of an interface in order to manage various pieces of information relating to the consumables of the development devices (toner cartridges).

While the connectors at the side of the main body and the corresponding connectors at the side of the development devices are mechanically engaged to mutually exchange data, they may alternatively be adapted to exchange data in a non-contact manner by an electromagnetic means, or by radio communications in other words. The memories for storing data specific to the development devices 4Y, 4C, 4M, 4K are preferably non-volatile memories so that they store the data when the power supply is turned off or when any of the development devices are taken out from the main body.

While not shown in FIG. 1, the image forming apparatus is also provided with a display section. Thus, whenever necessary, a predetermined message is displayed on the display section according to the control command issued from the CPU of the main controller in order to notify the user of necessary information. For example, when the apparatus gets out of order or is in trouble because of a stuck sheet, the display section displays a message for notifying the user of the fact.

The display section may be realized by using a display apparatus such as a liquid crystal display. Alternatively, a warning lamp that is turned on or goes on and off whenever necessary may be used. An audio warning device that sounds a prerecorded message or a buzzer may be used in addition to or in combination with visually notifying the user by displaying a message.

FIG. 2 is a schematic block diagram of the embodiment of FIG. 1, showing the electric connections between the control substrate 50 of the engine controller 10 and the load of the apparatus. In the illustrated instance, the control substrate 50 is made to operate as control section of the image forming apparatus. Note, however, the electrically conductive connecting section between the control substrate 50 and the load is omitted from FIG. 2 for the purpose of simplicity. Referring to FIG. 2, the control section 50 is equipped with a CPU 101, a ROM 104 and a RAM 105 along with a driver/buffer 102 for driving components such as motor and a driver/buffer 103 for option substrates 81e, 82e, 83e, which are relay substrates.

The control substrate 50 is connected to a sheet conveyance system 180 including a sheet conveyance motor 181, a sheet conveyance sensor 182 and a sheet conveyance clutch 183, a fixing unit 9, a photosensitive unit 2, an exposure unit 6, a charging unit 3, a development unit 4, a transfer unit 7 and so on by way of the driver/buffer 102. Additionally, the control substrate 50 is also connected to various components (not shown) of the image forming apparatus including a main controller, a cartridge memory (CS memory) that is arranged in the rotary development unit 4, various motors such as a scanner motor, electromagnetic power means such as a solenoid and a clutch, gauging means such as a fixing thermister and a patch sensor, various sensors such as a rotary position sensor, a new or used photosensitive member discriminating fuse, various fans such as a power source cooling fan, an eraser, a 24V type power source, an interlock switch of a 5V type power source, a high voltage power source connected to the development devices, low voltage power sources such as a 5V power source and a 24V power source and so on. The wiring terminal of the control substrate 50 and each of the components are connected to each other by way of a cable or a lead wire. Thus, signal transmission paths having different current capacities are formed. In other words, wiring patterns of current capacities that correspond to the current capacities of the signal transmission paths are formed.

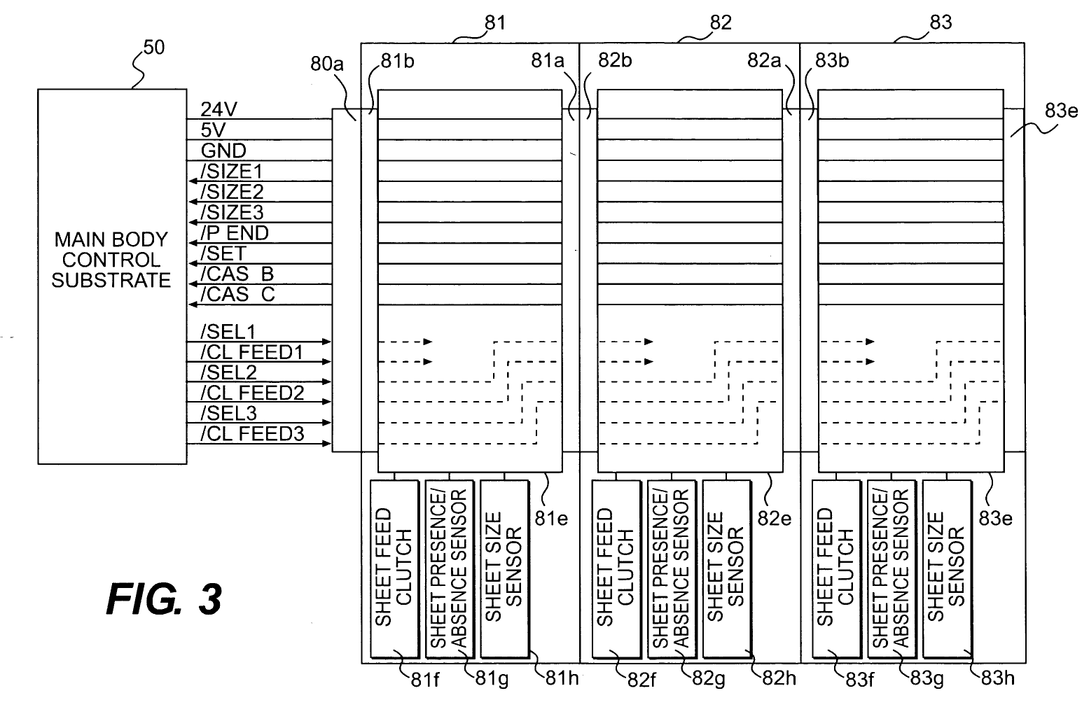

FIG. 3 is a schematic connection diagram of the main body control substrate 50 and the multiple sheet feed unit 8 of the image forming apparatus 1 of this embodiment. Referring to FIG. 3, the main body control substrate 50 and the optional substrates 81e, 82e, 83e of the sheet feed units 81, 82, 83 are connected to each other by way of the connectors 80a, 81b, 81a, 82b, 82a, 83b, 83a and communication lines. The communication lines will be described in greater detail here. In FIG. 3, from above, the first and second communication lines are respectively a +24V line and a +5V line for applying supply voltages. The third communication line is a GND line and the fourth through sixth communication lines are sheet size detection lines SIZE 1 through SIZE 3, whereas the seventh communication line is a sheet presence/absence detection line P_END and the eighth communication line is a mounted sheet feed unit detection line SET. The ninth and tenth communication lines are unit type determination lines CAS_B and CAS_C and the eleventh through sixteenth communication lines are selection control lines SEL1, SEL2, SEL3 and clutch control lines CLFEED1, CLFEED2, CLFEED3.

The sheet feed units 81, 82, 83 are equipped respectively with sheet feed clutches 81f, 82f, 83f, sheet presence/absence detection sensors 81g, 82g, 83g and sheet size sensors 81h, 82h, 83h.

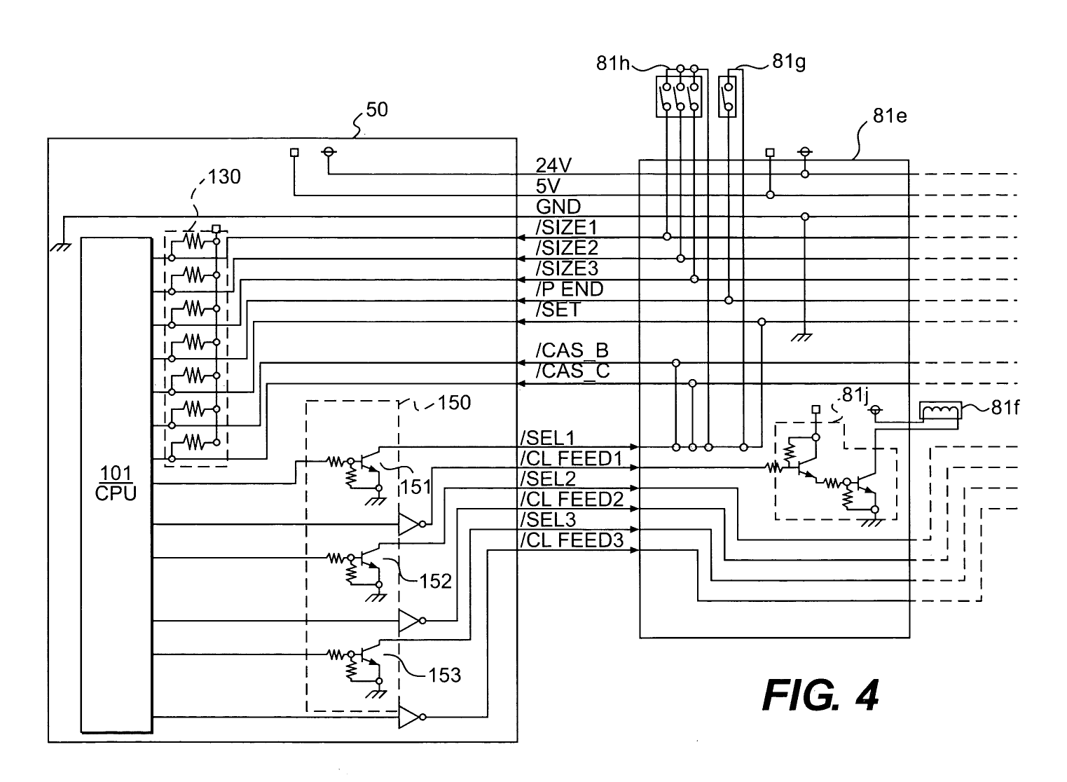

FIG. 4 is a schematic connection circuit diagram of the main body control substrate 50 and the multiple sheet feed unit of the image forming apparatus 1 of this embodiment. Referring to FIG. 4, the components relating to the second sheet feed unit 82 and the third sheet feed unit 83 are same as those relating to the first sheet feed unit 81 and hence are not shown. As shown in FIG. 4, the CPU 101 of the main body control substrate 50 that controls the communications with the multiple sheet feed unit 8 is arranged in the image forming apparatus main body 1a. Each of the ports of the CPU 101 is electrically connected to the connector 80a by the communication line directly or by way of a buffer. In the following description, a same symbol will be used to refer to one of the ports of the CPU 101 and the communication line that corresponds to the port unless they need to be discriminated from each other.

Of the ports of the CPU 101, the sheet size detection port SIZE1 through SIZE3, the sheet presence/absence detection port P_END, the mounted sheet feed unit detection port SET and the unit type determination ports CAS_B and CAS_C are ports equipped with respective pull-up resistors that belong to a resistor assembly 130. As will be described in greater detail hereinafter, the communication lines connected to these ports operate as data signal lines for receiving the sensor outputs from the sheet feed units 81, 82, 83.

The selection control ports SEL1, SEL2, SEL3 are output ports to be used for selecting one of the first sheet feed unit 81, the second sheet feed unit 82 and the third sheet feed unit 83 as object of communication. These ports are connected to respective open collector buffers that belong to a transistor array 150. When one of the ports is brought to level H, the transistor connected to the port is turned on so as to become able to suck the output currents from sensors, which will be described in greater detail hereinafter. When, on the other hand, any of the ports is held to level L, no electric current runs through the transistor connected to the port because the transistor cuts it off. In this way, the selection control ports SEL1, SEL2, SEL3 operate as communication lines for selecting a sheet feed unit 8 as object of communication by establishing or shutting off an electric current flow path between each of the sheet feed units 8 and the image forming apparatus main body 1a.

The clutch control ports CLFEED1, CLFEED2, CLFEED3 are output ports for controlling respectively the electromagnetic clutches 81f, 82f, 83f of the sheet feed units 81, 82, 83. In other words, the clutch control lines CLFEED1, CLFEED2, CLFEED3 are communication lines for controlling the electromagnetic clutches 81f, 82f, 83f of the sheet feed units 81, 82, 83. The connectors 80 are additionally provided with terminals for supplying supply voltages to other units and including a +24V terminal, a +5V terminal and a GND terminal.

On the other hand, the sheet feed unit 81 is equipped with three sheet size detection sensors 81h that are arranged at different positions and a sheet presence/absence detection sensor 81g as elements to be controlled. Thus, it is possible to determine the presence or absence of a sheet and, if a sheet is present, the size of the sheet in the sheet feed unit 81 according to the outputs of these sensors. The sensors 81h, 81g are typically micro-switches that are turned on/off in response to the presence or absence of mechanical pressure applied to it, although they may be replaced by optical means such as photo-interrupters for detecting the presence or absence of a sheet and, if a sheet is present, the size of the sheet. The sensors 81h, 81g are connected at one of the opposite ends thereof respectively to the sheet size detection lines SIZE1 through 3 and the sheet presence/absence detection line P_END, whereas the other ends of the sensors 81h, 81g and the mounted sheet feed unit detection line SET are connected to the selection control line SEL1.

Additionally, the sheet feed unit 81 is also equipped with an electromagnetic clutch 81f for driving the sheet feed roller 81d and a driver transistor 81j for controlling on/off of the electromagnetic clutch 81f so that the sheet feed roller 81d is driven to operate as the driver transistor 81j is turned on/off according to the control signal from the image forming apparatus main body 1a. More specifically, the base terminal of the driver transistor 81j is connected to the clutch control line CLFEED1 and the electromagnetic clutch 81f is connected to between the +24V power supply in the image forming apparatus main body 1a and the collector terminal of the driver transistor 81j. As a level H signal is output to the output port DLFEED1 of the CPU 101 of the image forming apparatus main body 1a and the clutch control line CLFEED1 is brought to level H, the driver transistor 81j is turned on and an electric current flows to the electromagnetic clutch 81f to drive the sheet feed roller 81d to rotate. On the other hand, so long as the clutch control line CLFEED1 is held to level L, the driver transistor 81j cuts off any electric current and hence no electric current flows to the electromagnetic clutch 81f.

Of the communication lines connected to the image forming apparatus main body 1a by way of the connector 81b, the four communication lines SEL2, CLFEED2, SEL3 and CLFEED3 are not used in the inside of the sheet feed unit 81 but directly connected to the connector 81a. In other words, the sheet feed unit 81 simply operate as relay for the communication lines.

The positional arrangements of the contact points of the two connectors 81b, 81a corresponding to these communication lines are not same and identical. More specifically, the communication lines of the connector 81a are shifted upwardly by two contact points in FIG. 4 relative to the communication liens of the connector 81b. In other words, if the contact points of the connectors 81b, 81a are referred to as the first pin, the second pin, . . . , the sixteenth pin from above in FIG. 4, the selection control line SEL2, the clutch control line CLFFED2, the selection control line SEL3 and the clutch control line CLFEED3 are assigned respectively to the thirteenth through sixteenth pins in the upstream side connector 81b, whereas the corresponding lines are assigned respectively to the eleventh through fourteenth pins in the downstream side connector 81a and the fifteenth and sixteenth pins are grounded.

The above-described arrangement provides the following advantages. Form the viewpoint of the first sheet feed unit 81 that is connected at the most upstream side among the cascade-connected units, the selection control line SEL1 and the clutch control line CLFEED1 that correspond to it are connected respectively to the eleventh pin and the twelfth pin of the upstream side connector. On the other hand, from the viewpoint of the second sheet feed unit 82 connected and arranged at the downstream side of the first sheet feed unit 81, the selection control line SEL2 and the clutch control line CLFEED2 that correspond to it are also connected respectively to the eleventh pin and the twelfth pin of the upstream side connector. The above description also applies to the third sheet feed unit 83.

Thus, the eleventh pins of the upstream side connectors 81b, 82b, 83b are the positions of the contact points where the selection control lines SEL1, SEL2, SEL3 that respectively correspond to them are assigned and the twelfth pins of the upstream side connectors 81b, 82b, 83b are the positions of the contact points where the clutch control lines CLFEED1, CLFEED2, CLFEED3 that respectively correspond to them are assigned. Therefore, the sheet feed units 8 only need to be configured so as to operate according to the signals input from the eleventh pin and the twelfth pin of the respective upstream side connectors 81b, 82b, 83b. In other words, as the internal wirings between the upstream side connectors 81b, 82b, 83b of the sheet feed units 81, 82, 83 and the downstream side connectors 81a, 82a, 83a are arranged in the above-described manner, the sheet feed units 81, 82, 83 can have a same circuit configuration. The above-described relationship holds true regardless of the order of mounting the sheet feed units 81, 82, 83. Thus, the three sheet feed units 81, 82, 83 are electrically mutually interchangeable.

Additionally, from the viewpoint of the image forming apparatus main body 1a, since the selection control line SEL1 and the clutch control line CLFEED1 are connected to the first sheet feed unit 81 and the selection control line SEL2 and the clutch control line CLFEED2 are connected to the second sheet feed unit 82, while the selection control line SEL3 and the clutch control line CLFEED3 are connected to the third sheet feed unit 83, it is possible for the image forming apparatus main body 1a to reliably and individually control the sheet feed units 81, 82, 83 by operating the control lines.

On the other hand, of the communication lines connected to the connector 81b at the upstream side of the first sheet feed unit 81, the eight upstream side ones including those connected to the first through eighth pins (from +24V to SET) are connected to the internal circuits of the above-described sensors and the sheet feed unit 81 and also to the first through eighth pins of the connector 81a. Therefore, when a plurality of sheet feed units 81, 82, 83 are mounted, the sensors that are elements to be controlled arranged in the sheet feed units 81, 82, 83 are connected in parallel as viewed from the image forming apparatus main body 1a.

Additionally, the ninth pin and the tenth pin that are connected to the connector 81b are also connected to the selection control line SEL1 and the unit type determination lines CAS_B and CAS_C that are connected to the ninth pin and the tenth pin of the connector 81a to determine the type of each of the sheet feed units 81, 82, 83.

Now, the operation of the image forming apparatus when the sheet feed units 81, 82, 83 are mounted in the image forming apparatus main body 1a will be described below. As the plurality of sheet feed units 81, 82, 83 are connected to the image forming apparatus main body 1a, the sheet size detection sensor 81h arranged at the first sheet feed unit 81 and the sheet size detection sensor 82h arranged at the second sheet feed unit 82 are connected at one of the opposite ends thereof to the image forming apparatus main body 1a by way of the sheet size detection lines SIZE1, SIZE2, SIZE3 in parallel. Similarly, the sheet presence/absence detection sensors 81g on the first sheet feed unit 81 is connected in parallel with the sheet presence/absence detection sensor 82g on the second sheet feed unit 82.

The other ends of the sensors are connected respectively to the inside of the sheet feed units 81, 82, 83 and also to the collectors of the transistors 151, 152, 153 of the transistor array 150. Therefore, when, for example, the CPU 101 brings the port SEL1 to level H to turn on the transistor 151 connected to the port SEL1 and activate the selection control line SEL1, an electric current flow path is established from the +5V power source that passes the pull-up resistor 130, the data signal lines, the sensors 81h, 81g and the transistor 151. Therefore, if either of the sensors 81h, 81g whose contact point is closed, the input port of the CPU 101 that corresponds to the sensor is held to level L. If, on the other hand, either of the sensors 81h, 81g whose contact point is open, the input port of the CPU 101 that corresponds to the sensor is held to level H. In this way, the CPU 101 can determine the state of each of the sensors 81h, 81g on the first sheet feed unit 81 such as the presence or absence of a sheet and, if a sheet is present, the size of the sheet in the first sheet feed unit 81. With the above-described arrangement, it is possible to transmit a plurality of pieces of information including the outputs of a plurality of sensors to the image forming apparatus main body 1a instantaneously. Additionally, there is no risk of missing signals due to intrusions of noises and hence it is possible to communicate stably.

The mounted sheet feed unit detection line SET is connected to the other end of each of the sensors in the inside of the first sheet feed unit 81, the mounted sheet feed unit detection port SET is always held to level L when the CPU 101 activates the selection control line SEL1 so long as the first sheet feed unit 81 is mounted properly. Conversely, the mounted sheet feed unit detection port SET is held to level H so long as the first sheet feed unit 81 is not mounted. Therefore, it is possible for the CPU 101 to determine if the first sheet feed unit 81 is mounted or not from the state of the mounted sheet feed unit detection line SET.

Similarly, as for remaining sheet feed units including the second sheet feed unit 82 and the third sheet feed unit 83, it is possible to detect the state of each of the sheet feed units 82, 83 by activating the selection control line 82 or 83 that corresponds to the second sheet feed unit 82 or the third sheet feed unit 83, whichever appropriate.

Additionally, the unit type determination lines CAS_B, CAS_C are connected to the contact point B and the contact point C respectively as unit type determination means fitted to the sheet feed units 8. The combination of the contact points is operated in different ways depending on the types of sheets contained in the sheet feed units 8. For example, only the contact point B is closed for the sheet feed unit 81 when it is for containing 500 sheets and only the contact point C is closed for the sheet feed unit 81 when it is for containing sheets of special paper. As the contact points are arranged in this way, the unit type determination line CAS_B is connected to the selection control line SEL1 when the sheet feed unit 81 for containing 500 sheets that closes the contact point B is mounted and the input port of the CPU 101 that corresponds to the unit type determination line CAS_B is held to level L. Similarly, the unit type determination line CAS_C is connected to the selection control line SEL1 when the sheet feed unit 81 for containing sheets of special paper that closes the contact point C is mounted and the input port of the CPU 101 that corresponds to the unit type determination line CAS_C is held to level L.

When the sheet feed unit 82 for containing 250 sheets that opens both the contact point B and the contact point C is mounted, neither the unit type determination line CAS_B nor the unit type determination line CAS_C is connected to the selection control line SEL1 and the input ports of the CPU 101 that correspond respectively to the unit type determination lines CAS_B and CAS_C are held to level H so that it is determined that the mounted sheet feed unit 8 is the sheet feed unit 82 for containing 250 sheets.

For the purpose of the present invention, it is possible to mount sheet feed units 8 of more different types by in creasing the number of contact points and that of communication lines.

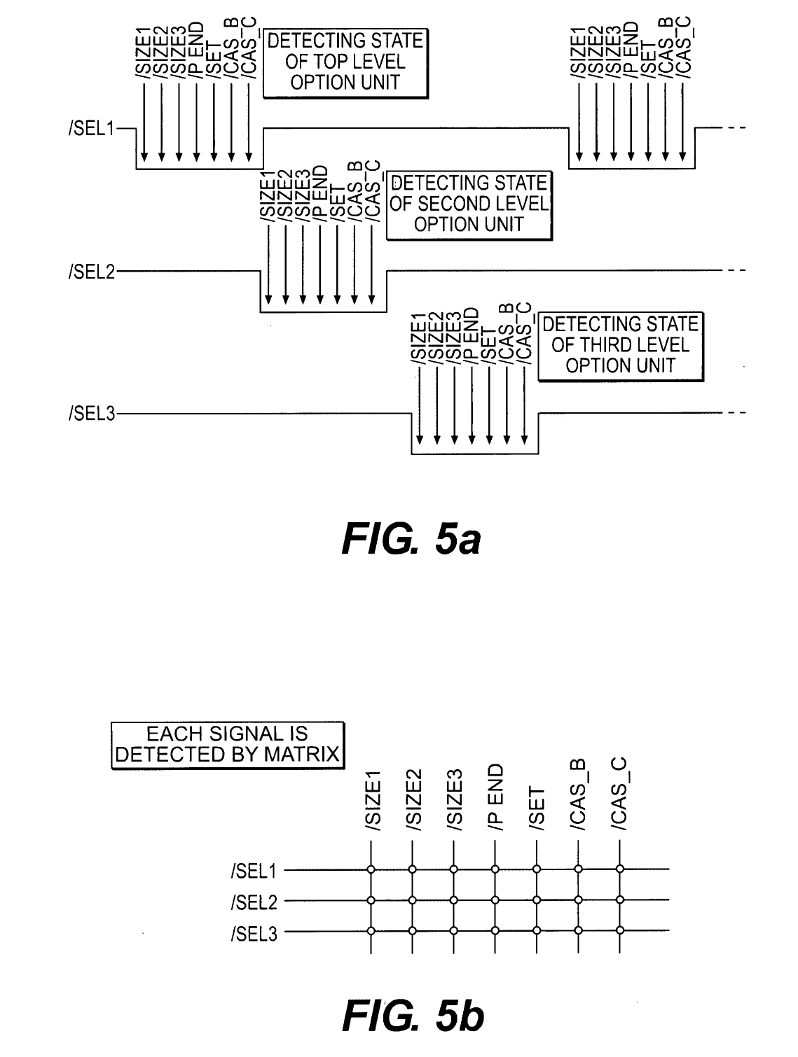

Now, the signal detection timing of this embodiment will be described below. FIG. 5A is a timing chart of signal detection of the image forming apparatus 1 and the sheet feed units 8. In the image forming apparatus 1, the CPU 101 sequentially determines the state of each of the three sheet feed units 81, 82, 83 including the mounting or non-mounting of the units 81, 82, 83, the presence or absence of a sheet, the size of the sheet, and the type of the sheet feed unit.

Firstly, the CPU 101 detects the state of the sheet feed unit of the top level. As the CPU 101 activates the selection control line SEL1, one of the sheet size detection ports SIZE1, SIZE2, SIZE 3, the sheet presence/absence detection port P_END, the mounted sheet feed unit detection port SET and either or both of the unit type determination ports CAS_B, CAS_C are turned to level L. Then, as the CPU 101 activates the selection control line SEL2, it is also possible to detect the state of the sheet feed unit 8 of the second level. Similarly, as the CPU detects the state of the sheet feed unit 8 of the third level to complete the operation of detecting the state of each of the sheet feed units. Then, the CPU 101 starts again the state of the sheet feed unit 8 of the top level and so on. In other words, the CPU 101 detects each signal by means of a matrix as shown in FIG. 5B.

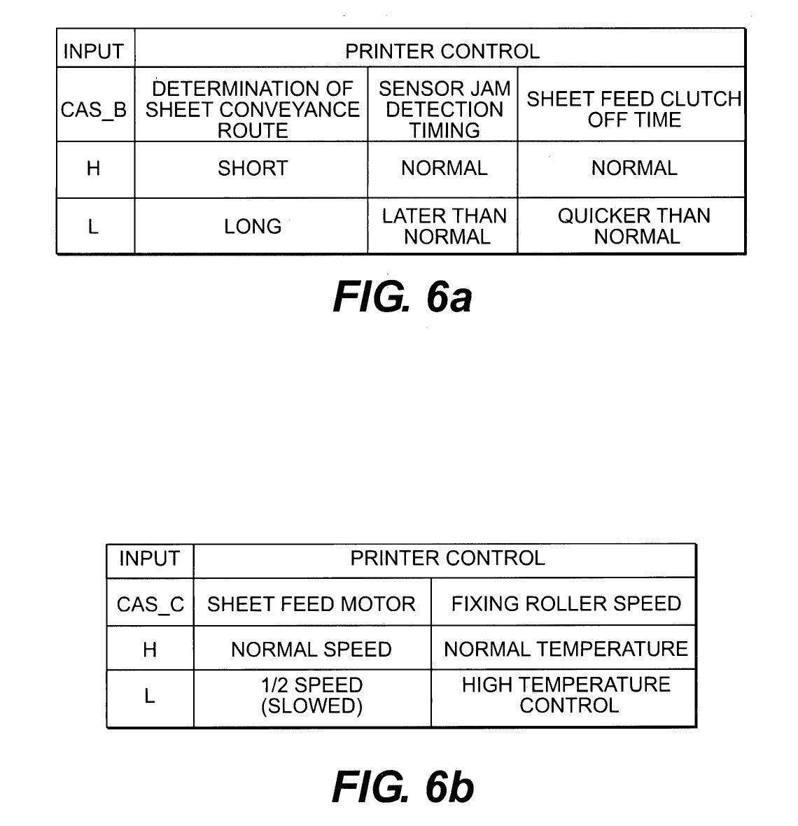

Now, the operation of the image forming apparatus 1 for controlling the type of unit will be described below. FIG. 6A is a schematic illustration of the operation of the image forming apparatus 1 for controlling the types of the units having different sheet containing capacities. The sheet conveyance route, the detection timing of the sensor JAM and the OFF time of the sheet feed clutch of the image forming apparatus 1 are controlled by using CAS_B as input. When CAS_B is at level H, the sheet conveyance route is set to be short and both the detection timing of the sensor JAM and the OFF time of the sheet feed clutch are set to be normal. The sheet conveyance route is determined to be long when CAS_B is at level L because a 500 sheets cassette is mounted. Because the conveyance route is longer than the normal distance and a sheet gets to the JAM sensor of the main body late when a 500 sheets cassette is mounted, the detection timing of the JAM sensor is so controlled as to be late relative to the normal timing. Additionally, because the conveyance route is longer than the normal distance and the timing for the rear end of a sheet to pass the sheet feed roller is late when a 500 sheets cassette is mounted, the OFF time of the sheet feed clutch is so controlled as to be relatively early.

FIG. 6B is a schematic illustration of the operation of the image forming apparatus 1 for controlling unit types for different types of sheets. Both the sheet feed motor and the fixing roller temperature are controlled in the image forming apparatus 1 by using CAS_C as input. The sheet feed motor and the fixing roller temperature are set to an ordinary level when the CAS_C is at level H. When CAS_C is at level L because a special paper cassette containing cardboards is mounted, the sheet feed motor is controlled so as to rotate at a speed of ½ of the normal speed and prolong the fixing time and the fixing roller temperature of the fixing unit 9 is held high because a cardboard has a greater required thermal capacity.

In this way, it is possible to determine the type of each of the sheet feed units 8 simply by adding unit type determination lines CAS_B, CAS_C and so on between the engine controller 10 and the sheet feed units 8. Thus, it is no longer necessary to unequivocally define the mounting position of each of the sheet feed units 8 and a stuck sheet condition can be accommodated by controlling the sheet conveyance system 180 and other systems if the length of the sheet conveyance route from each of the sheet feed units 8 to the image forming apparatus main body 1a is changed depending on the location where the sheet feed unit is mounted. Therefore, the mounting positions of the sheet feed units are vertically interchangeable to raise the degree of freedom of mounting option units. Additionally, the CPU 101 of the engine controller 10 can control the sheet conveyance system 180 and the fixing unit 9 according to the sheet type by determining the type of each of the sheet feed units 8. For example, it is possible to form an image on a sheet of special paper such as a cardboard without any problem.

For the purpose of the present invention, option units are not limited to sheet feed units 8 and other units maybe made optional. Additionally, since it is only necessary to increase the number of unit type determination means and the number of unit type determination lines if the number of units is increased so that it is no longer necessary to limit the number of units. In short, the number of units can be increased with ease.

Finally, the unit type is determined by means of a plurality of opening/closing patterns such as contact points. Thus, it is possible to determine four unit types by using two contact points and two unit type determination lines and eight unit types by using three contact points and three unit type determination lines. Therefore, it is possible for any existing system to determine a large number of unit types simply by adding a small number of components. In other words, the number of units that can be used in an image forming apparatus can be increased with ease.

What is claimed is:

1. An image forming apparatus comprising an apparatus main body connected to a plurality of option units by way of communication lines by cascade connection and adapted to communicate with an element to be controlled and a unit type determining means arranged in each of the plurality of option units by way of the communication lines; and
the communication lines including:
data signal lines connecting the element to be connected arranged in each of the plurality of option units in parallel relative to the apparatus main body for data communications between each of the elements to be controlled and the apparatus main body;
unit type determination signal lines connecting the unit type determination means arranged respectively for the plurality of option units to the apparatus main body for data communications between each of the unit type determination means and the apparatus main body; and
selection control lines arranged corresponding to the number of cascade-connected option units relative to the apparatus main body to select an option unit as object of data communication of the apparatus main body.

2. The apparatus according to claim 1, wherein
the apparatus main body is adapted to form an electric current flow path between the element to be controlled arranged in an option unit that corresponds to one of the selection control lines out of the option units and the unit type determination means and the apparatus main body itself by way of the data signal lines by activating the selection control line.

3. The apparatus according to claim 1, wherein
each of the plurality of option units is equipped with an upstream side connector for electrically connecting the communication lines between the option unit and the option unit cascade-connected at the upstream side and arranged closer to the apparatus main body in terms of order of connection or the apparatus main body and a downstream side connector for electrically connecting the communication lines between the option unit and the option unit cascade-connected at the downstream side and arranged at the side opposite to the upstream side in terms of order of connection.

4. The apparatus according to claim 3, wherein
the upstream side connector arranged in each of the plurality of option units, the main body side connector arranged in the apparatus main body and the downstream side connector arranged in each of the plurality of option units have a structure that allows them to be mutually connected.

5. The apparatus according to claim 3, wherein
each option unit is provided in the inside thereof with a relay substrate for mutually connecting the straight connection harnesses that are connected respectively to the upstream side connector and the downstream side connector.

6. The apparatus according to claim 3, wherein
the internal wiring of each of the plurality of option units is arranged between the upstream side connector and the downstream side connector thereof in such a way that the contact point of the upstream side connector assigned to the selection control line corresponding to the option unit is same throughout the option units.

7. The apparatus according to claim 1, wherein
the plurality of option units are made to be functionally identical.

8. The apparatus according to claim 1, wherein
the unit type determination means determines the type of an option unit simply by opening/closing the contact point.
